(19) United States
(12) Patent Application Publication
(10) Pub. No.: US 2025/0236287 A1
(43) Pub. Date: Jul. 24, 2025

(54) APPARATUS AND METHOD FOR CONTROLLING VEHICLE MOVEMENT

(71) Applicant: Jaguar Land Rover Limited, Coventry (GB)

(72) Inventors: Daniel WOOLLISCROFT, Birmingham (GB); Edward PITHER, Wolvey (GB); Helio CARDOSO, Coventry (GB); David PETTINGER, Coventry (GB)

(21) Appl. No.: 19/173,776

(22) Filed: Apr. 8, 2025

Related U.S. Application Data
(63) Continuation of application No. 18/404,811, filed on Jan. 4, 2024.
Application No. 18/404,811 is a continuation of application No. 17/829,305, filed on May 31, 2022, now Pat. No. 11,897,456.
Application No. 17/829,305 is a continuation of application No. 15/733,877, filed on Nov. 30, 2020, now Pat. No. 11,345,336.

(30) Foreign Application Priority Data
May 31, 2018 (GB) 1808895.5
May 31, 2018 (GB) 1808896.3
May 31, 2018 (GB) 1808898.9
May 31, 2018 (GB) 1808900.3
May 31, 2018 (GB) 1808902.9
May 31, 2018 (GB) 1808906.0
May 31, 2018 (GB) 1808908.6
May 31, 2018 (GB) 1808911.0
May 31, 2018 (GB) 1808917.7
May 31, 2018 (GB) 1808919.3
May 31, 2018 (GB) 1808920.1
Nov. 2, 2018 (GB) 1817940.8

(51) Int. Cl. B60W 30/06; B60W 60/00; G06F 9/38; G06V 20/56; G08G 1/14

(52) U.S. Cl. CPC B60W 30/06; B60W 60/001; G06F 9/3838; G06V 20/56; G08G 1/148

(57) ABSTRACT

Embodiments of the present invention provide a controller, comprising input means for receiving an environment signal indicative of a feature in a vicinity of a vehicle, output means for outputting a manoeuvre signal to cause a vehicle to perform a defined manoeuvre, and control means arranged to provide at least one mode for performing at least a portion of the defined manoeuvre, the mode being selectable from a plurality of modes including at least one mode corresponding to an occupant-in-vehicle mode and at least one mode corresponding to an occupant-out-of-vehicle mode, the mode being selectable in dependence upon the environment signal being indicative of a vehicle envelope suitable for the mode.

### TECHNICAL FIELD

The present disclosure relates to controlling movement of a vehicle and particularly, but not exclusively, to controlling performance of a defined manoeuvre by the vehicle. Aspects of the invention relate to a controller, to a system, to a method, to a vehicle and to computer software.

The present disclosure relates also to determining an orientation of a completed position of a vehicle, particularly, but not exclusively, to determining an orientation of a defined manoeuvre completed position of the vehicle. Aspects of the invention relate to a controller, to a system, to a method, to a vehicle and to computer software.

### BACKGROUND

It is known for a vehicle to perform a defined manoeuvre, such as an automatic, or semi-autonomous, parking manoeuvre. A user typically instructs the vehicle to identify a possible defined manoeuvre when the owner is ready, such as when the owner is looking for or at a parking location. The vehicle may be instructed to perform the manoeuvre remotely e.g. via a mobile device at which a user input is received to instruct the manoeuvre.

Environment sensing means of the vehicle are used to determine a location of features in a vicinity of the vehicle such as, although not exclusively, markings, walls, posts, other vehicles etc. The vehicle may then be instructed, such as via the mobile device or other input medium, to move to a parked location in relation to the features. For example, it may be desired for a vehicle to move into a parking space bounded by the features. In order to prevent the vehicle contacting an object the environment sensing means determines a distance between the vehicle and the object and the automatic parking manoeuvre is performed to leave the vehicle a separation distance from the object. For example, the vehicle may be reversed towards the feature, until an appropriate separation distance is determined by the environment sensing means. If a space is large enough to receive the vehicle, the vehicle is parked in the middle of the space-for example, to be positioned in the centre of a garage. Once the vehicle has reached a completed parked position, the vehicle is switched off, typically with a parking brake applied.

Sometimes the features bounding a parking space can inhibit access to or from the vehicle. For example, a wall adjacent a parking space can impede the opening of a vehicle door, impeding or preventing access via that door.

Driver preference can be to leave the vehicle steered wheels straightened when parked, such as to appear tidy or prevent a vehicle wheel from protruding laterally. In other situations, it is preferred or even required to cramp vehicle wheels on sloping terrain of any gradient.

The defined manoeuvre is typically performed in various ambient conditions, such as irrespective of weather or lighting.

Sometimes the features bounding a parking space can inhibit access to the space for a vehicle. For example, a parking space may be too narrow to allow the vehicle to manoeuvre into or out of the parking space, such as with sufficient clearance, or even be too narrow to receive the vehicle as such (e.g. narrower than a maximum width of the vehicle).

Defined manoeuvres can be performed on different terrains, such as differing ground surface type or smoothness.

Sometimes drivers like the vehicle to be neatly parked, desiring a precise parked position of the vehicle. Often drivers like the defined manoeuvre to be performed swiftly.

The vehicle may be instructed to perform the manoeuvre remotely e.g. via a mobile device at which a user input is received to instruct the manoeuvre. Alternatively the vehicle may be instructed to perform the manoeuvre with the user in the vehicle.

Performance of the manoeuvre generally moves the vehicle from a start position, such as outside the parking space, to a completed position, such as in the parking space. If the vehicle has reached a completed parked position, the user can switch the vehicle off, typically with a parking brake applied.

Once the vehicle has completed the defined manoeuvre the user can control the vehicle, such as to drive manually. If the vehicle has reached a completed parked position, the user can switch the vehicle off, typically with a parking brake applied.

It is an object of embodiments of the invention to at least mitigate one or more of the problems of the prior art.

### SUMMARY OF THE INVENTION

Aspects and embodiments of the invention provide a controller, a system, a method, a vehicle and computer software as claimed in the appended claims.

According to an aspect of the invention, there is provided a controller arranged to operably cause a vehicle to continue a user-initiated manoeuvre as a defined manoeuvre.

According to an aspect of the invention, there is provided a controller comprising: input means for receiving an input signal; manoeuvre output means for outputting a manoeuvre signal to cause a vehicle to perform a defined manoeuvre; control means arranged to control the manoeuvre output means; notification output means for outputting a notification signal for notifying a user; and request input means for receiving a request signal indicative of a user request for a transfer of control from the user to the control means for a continuance of a user-initiated manoeuvre as a defined manoeuvre; the control means being arranged to control the manoeuvre output means to perform the defined manoeuvre from a user-initiated manoeuvre end position in dependence on the request signal. Advantageously, the vehicle may be caused to perform a defined manoeuvre from a non-specific defined manoeuvre start position, such as corresponding to any user-initiated manoeuvre end position or not a prescribed defined manoeuvre start position.

The controller as described above, wherein:
the input means may comprise an electrical input for receiving the signal;
the output means may comprise an electrical output for outputting the signal; and
the control means may comprise one or more control devices such as electronic processing devices.

The defined manoeuvre may comprise a parking manoeuvre. The parking manoeuvre may comprise an in-parking manoeuvre, such as parking into a space to a stationary position. The parking manoeuvre may comprise an un-parking manoeuvre, such as parking out of a space from a stationary position. The defined manoeuvre completed position may comprise a parked position.

The user-initiated manoeuvre may comprise a parking manoeuvre. The user-initiated parking manoeuvre may comprise a partial parking manoeuvre, such as to an incomplete parking position (e.g. not fully in or out of a parking place). The parking manoeuvre may comprise an in-parking manoeuvre, such as parking into a space to a stationary position. The parking manoeuvre may comprise an un-parking manoeuvre, such as parking out of a space from a stationary position. The user-initiated manoeuvre end position may comprise a stationary vehicle position.

The control means may be arranged to detect performance of the user-initiated manoeuvre, in dependence on the input signal. The control means may be arranged to control the notification output means to notify the user of the detection by the control means of the user-initiated manoeuvre. Advantageously, the user may be alerted to a possibility of the performance of the defined manoeuvre.

The control means may be arranged to control the notification output means to automatically output the notification signal on detection by the control means of the user-initiated manoeuvre. The control means may be arranged to offer the user continuance as a defined manoeuvre. Advantageously the user may be offered the possibility of the performance of the defined manoeuvre without necessarily explicitly requesting or seeking the possibility.

The control means may be arranged to control the notification output means to output the notification signal independently of a user request for the manoeuvre output means to be controlled by the control means. Advantageously, the controller may be configured to automatically output the notification signal without requiring an activation of the control means by the vehicle user. For example, the user may otherwise be unaware of the possibility of the performance of a defined manoeuvre (such as in a particular scenario) such that allowing the notification signal to be output independently of the user request may allow the user to be offered the possibility of more or more useful defined manoeuvres (e.g. compared to only those expressly sought by the user in advance).

The control means may be arranged to control the notification output means in dependence at least partially on the input signal received prior to the user-initiated manoeuvre to the user-initiated manoeuvre end position. Advantageously the control means may be able to determine from the prior input signal whether one or more defined manoeuvres is possible (e.g. where the prior input signal comprised data no longer available via a corresponding input means).

The control means may be configurable to suppress the notification output means, such as from notifying the vehicle user of the detection by the control means of the user-initiated manoeuvre. Advantageously, the user can customise the control means. For example, in a scenario or type of scenario where the user may not wish to perform a defined manoeuvre (e.g. where the user has a different identity, such as when the vehicle has a different driver), then the control means can be configured not to notify the user.

The control means may be arranged to control the manoeuvre output means to cause the vehicle to follow a planned trajectory from the user-initiated manoeuvre end position to a defined manoeuvre completed position. Advantageously, the control means can determine a trajectory in advance for the vehicle to perform the defined manoeuvre.

The planned trajectory may comprise at least a partial correction of the user-initiated manoeuvre performed prior to the user request. Advantageously, at least a portion of the user-initiated manoeuvre can be corrected or undone. For example, where a user has entered or partially entered a parking space or location sub-optimally in a user-initiated parking manoeuvre, such as at an unsuitable angle of the vehicle relative to the space or location, the control means may be arranged to more suitably position the vehicle in the space or location; and/or arranged to remove the vehicle from the parking space or location (e.g. to entirely restart the parking as a defined manoeuvre).

The control means may be arranged to control the manoeuvre output means to cause the vehicle to perform a reversal of at least a portion of the user-initiated manoeuvre performed prior to the defined manoeuvre.

The controller may comprise memory means for storing data therein, the memory means being arranged to store data received via the input means.

The stored data may be indicative of a previously performed defined manoeuvre.

The control means may be arranged to control the manoeuvre output means to cause the vehicle to perform a repetition of at least a portion of the previously performed defined manoeuvre. The performance may be selective.

The control means may be arranged to control the manoeuvre output means to cause the vehicle to perform a reversal of at least a portion of the previously performed defined manoeuvre. The reversal may comprise a contra-manoeuvre or inversion. For example, the reversal may comprise an unparking manoeuvre of a previous parking manoeuvre, or a parking manoeuvre of a previous unparking manoeuvre.

The stored data may be indicative of a previously performed user-initiated manoeuvre.

The control means may be arranged to control the notification output means to notify the user in dependence on the previously-performed user-initiated manoeuvre having been followed by a defined manoeuvre.

The control means may be arranged to control the manoeuvre output means to perform the defined manoeuvre from a user-defined start position for the defined manoeuvre, the user-defined start position for the defined manoeuvre corresponding to the user-initiated manoeuvre end position. The start position for the defined manoeuvre may comprise an intermediate manoeuvre position, such as partially in and/or out of a vacancy

The input means may be arranged to receive a plurality of input signals from a plurality of input sources, the plurality of input signals being selected from at least:
an environment signal indicative of a feature in a vicinity of the vehicle;
a motion signal indicative of a motion of the vehicle;
a steering signal indicative of a user steering;
an event signal indicative of a vehicle event; and
a location signal indicative of a geographical location.

The controller may comprise input means for receiving a request signal indicative of a received signal indicative of a user request. The request signal may be indicative of a wired or a wirelessly received signal indicative of a user request, such as from a user's mobile device. Advantageously this may allow the vehicle to be effectively instructed from a user's mobile device, such as remotely instructed with the user out of the vehicle.

The user may comprise an occupant. The user may comprise a driver of the vehicle. The user may be located in the vehicle. The user may be located out of the vehicle, such as for at least a portion of performance of the defined manoeuvre. The vehicle may comprise one or more non-driver occupants. In at least some examples, one or more users and/or occupants may be located in and/or out of the vehicle.

The control means may be arranged to determine the vacancy. The control means may be arranged to define at least one vehicle envelope within the vacancy, the vehicle envelope being suitable for receiving the vehicle in the defined manoeuvre completed position. The control means may be arranged to define within the vacancy at least one defined manoeuvre completed position for the vehicle.

The vehicle envelope may comprise a target position suitable for receiving the vehicle in the defined manoeuvre completed position. The vehicle envelope may comprise a target defined manoeuvre completed position. The vehicle envelope may be determined in dependence on a one-dimensional property and/or measurement and/or estimation. The vehicle envelope may be determined in dependence on the environment signal being indicative of a length, such as an unobstructed length between features, the unobstructed length being sufficiently long for receiving the vehicle in the defined manoeuvre completed position. The vehicle envelope may be determined in dependence on a two-dimensional property and/or measurement and/or estimation. For example, the vehicle envelope may be determined in dependence on the environment signal being indicative of a length, such as between features, wherein along that length there is no obstruction within a particular width or breadth perpendicular to the length. The particular width or bready may correspond to at least a width or breadth of the vehicle, such as a vehicle width when the vehicle is parked and in a closed configuration, such as with vehicle aperture members closed. The particular width or breadth may correspond to at least a length of the vehicle, such as a vehicle length when the vehicle is parked and in the closed configuration in a perpendicular or parking lot or fishbone diagonal parked position. The vehicle envelope may comprise at least one dimension of a parking area and the defined manoeuvre completed position may be a parked position. The vehicle envelope may correspond to a predefined parking space. The vehicle envelope may comprise a target length, area or volume for receiving the vehicle in or on in the defined manoeuvre completed position.

The control means may be arranged to define at least two vehicle envelopes within the vacancy, each vehicle envelope comprising a discrete defined manoeuvre completed position that is offset within the vacancy.

The two vehicle envelopes may be non-overlapping. Alternatively, the two vehicle envelopes may be overlapping.

The two vehicle envelopes may extend in respective longitudinal directions adjacent and parallel each other. Alternatively, the two vehicle envelopes may extend along a same longitudinal axis, with a first vehicle envelope being longitudinally displaced along the longitudinal axis from a second vehicle envelope. In a yet further alternative, the vehicle envelops may be arranged with non-parallel longitudinal axes, such as with a first vehicle envelope having a longitudinal axis perpendicular to a longitudinal axis of a second vehicle envelope.

According to an aspect of the invention, there is provided a system, comprising: the controller as described above, arranged to output the manoeuvre signal; and actuator means for receiving the manoeuvre signal to cause the vehicle to perform the defined manoeuvre.

The system may comprise environment sensing means for determining the location of one or more features in the vicinity of the vehicle; and for outputting the environment signal indicative thereof.

The system may comprise receiver means. The receiver means may be for receiving a user signal indicative of the user request for continuance of the user-initiated manoeuvre as the defined manoeuvre with the manoeuvre output means controlled by the control means. The receiver means may be for outputting the request signal in dependence on receipt of the user signal. The receiver means may be for receiving a wired and/or wireless signal, such as from a mobile device indicative of the user request. Advantageously user requests can be received originating from external to the vehicle, so as to allow defined manoeuvre performance in at least some instances whilst the occupant is out of the vehicle.

The system may comprise a notification means for notifying the user.

According to an aspect of the invention, there is provided a method of controlling movement of a vehicle to perform a defined manoeuvre, the method comprising:
performing a user-initiated manoeuvre to a user-initiated manoeuvre end position;
receiving a request signal indicative of a user request to transfer control from a user to a control means for a continuance of the user-initiated manoeuvre as a defined manoeuvre;
controlling with the control means a manoeuvre output means to output a manoeuvre signal to cause the vehicle to perform the defined manoeuvre from the user-initiated manoeuvre end position.

The method may comprise receiving an input signal; and outputting a notification signal for notifying a user.

The method may comprise, in dependence on the input signal, detecting with the control means the user-initiated manoeuvre, notifying the user of the detection by the control means of the user-initiated manoeuvre; and offering transfer of control to the control means for the continuance of the user-initiated manoeuvre as the defined manoeuvre.

The method may comprise allowing the vehicle to revert to user control prior to completion of the defined manoeuvre to a defined manoeuvre completed position.

The method may comprise determining a location of one or more features in a vicinity of the vehicle with an environment sensing means.

The method may comprise receiving a signal from a mobile device indicative of a user request to perform the defined manoeuvre.

According to an aspect of the invention, there is provided a vehicle comprising a controller according to an aspect of the invention, a system according to an aspect of the invention or arranged to perform a method according to an aspect of the invention.

According to an aspect of the invention, there is provided computer software which, when executed by a processing means, is arranged to perform a method according to an aspect of the invention. The computer software may be stored on a computer readable medium. The computer software may be tangibly stored on a computer readable medium. The computer readable medium may be non-transitory.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers in a control system collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1a shows a vehicle in relation to a feature in a vicinity of the vehicle;

FIG. 1b shows the vehicle in relation to the feature in the vicinity of the vehicle in another scenario;

FIG. 2 shows a controller according to an embodiment of the invention;

FIG. 3 shows a system according to an embodiment of the invention;

FIG. 4 shows a method according to an embodiment of the invention;

FIG. 5a illustrates movement of a vehicle according to an embodiment of the invention;

FIG. 5b illustrates movement of a vehicle according to an embodiment of the invention in another scenario; and

FIG. 6 is a vehicle according to an embodiment of the invention.

### DETAILED DESCRIPTION

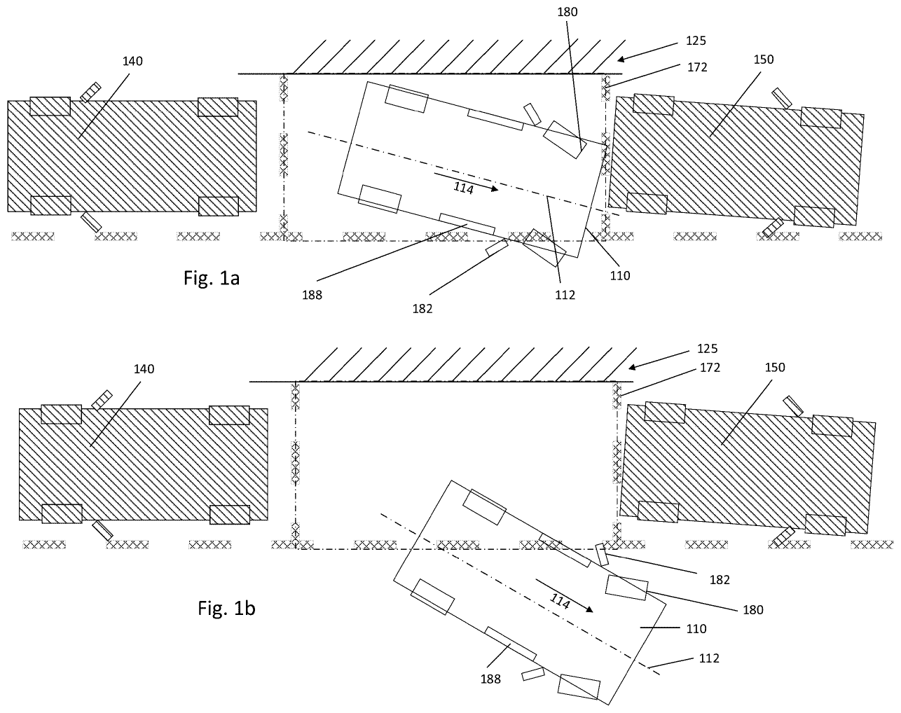

FIGS. 1a and 1b illustrate a vehicle 110 according to an embodiment of the invention in two example scenarios. In FIGS. 1a and 1b, the vehicle 110 is illustrated as having a vehicle forward direction, indicated by arrow 114, shown parallel to a central longitudinal axis 112 of the vehicle 110. In the illustrated scenarios, the vehicle 110 is shown at a user-initiated manoeuvre end position. In FIG. 1a, the vehicle 110 is shown at a user-initiated manoeuvre end position where the user-initiated manoeuvre has been a manoeuvre to attempt to exit a vacancy 172 in an unparking manoeuvre. In FIG. 1b, the vehicle 110 is shown at a user-initiated manoeuvre end position where the user-initiated manoeuvre has been a manoeuvre to attempt to enter the vacancy 172 in a parking manoeuvre. In each of the scenarios shown in FIGS. 1a and 1b, the user-initiated manoeuvre end positions may not correspond to positions where the user desires the vehicle to be ultimately positioned. The user may have difficulty or not wish to perform any further user-initiated manoeuvres from the positions shown in FIGS. 1a and 1b. Similarly, the user may not wish to re-position the vehicle to a predetermined or prescribed defined manoeuvre start position for a performance of a defined manoeuvre.

Embodiments of the present invention aim to ameliorate such problems.

In the particular scenario shown in FIG. 1a, it may be desirable to perform a defined manoeuvre to unpark the vehicle 110 to a defined manoeuvre completed position outside the vacancy 172. In the particular scenario shown in FIG. 1b, it may be desirable to perform a defined manoeuvre to park the vehicle 110 to a defined manoeuvre completed position inside the vacancy 172.

It will be understood in the scenarios shown in FIGS. 1a and 1b that the user-initiated manoeuvre end positions may correspond to defined manoeuvre start positions. The defined manoeuvres performed from the positions of FIGS. 1a and 1b may be manoeuvres of the vehicle 110 which are performed automatically by the vehicle 110 i.e. under control of one or more systems of the vehicle 110. The defined manoeuvre may be considered to be performed automatically by the vehicle 110, or at least semi autonomously. As shown, in FIG. 1a the defined manoeuvre may be an unparking manoeuvre to control the vehicle 110 to drive out of a parking place. As shown, in FIG. 1b the defined manoeuvre may be a parking manoeuvre to control the vehicle 110 to drive into a parking place.

As will be further explained, it may be advantageous for at least a portion of the defined manoeuvre to be performed whilst a person in control of the vehicle 110 is external to the vehicle 110. For example, access from the vehicle 110 may be limited in FIG. 1b after performing or at least completing the defined manoeuvre.

To perform the defined manoeuvre, the vehicle 110 comprises environment sensing means for determining a location of features 125, 140, 150 in the vicinity of the vehicle 110. The environment sensing means may comprise one or more sensing devices or imaging devices. The one or more sensing devices may emit radiation and receive radiation reflected from the features in the vicinity of the vehicle, such as ultrasonic sensing devices, although it will be appreciated that the present invention is not limited in this respect. Such environment sensing means have a minimum distance to which accuracy the location of the features 125 may be determined due to, for example, a resolution of an imaging device or a signal-to-noise ratio of a sensing device.

In the particular example shown here, the vehicle 110 comprises a portion of the environment sensing means in or on a vehicle moveable projection 182. For example, each side or wing mirror of the vehicle 110 can have a camera or the like mounted thereto or thereon.

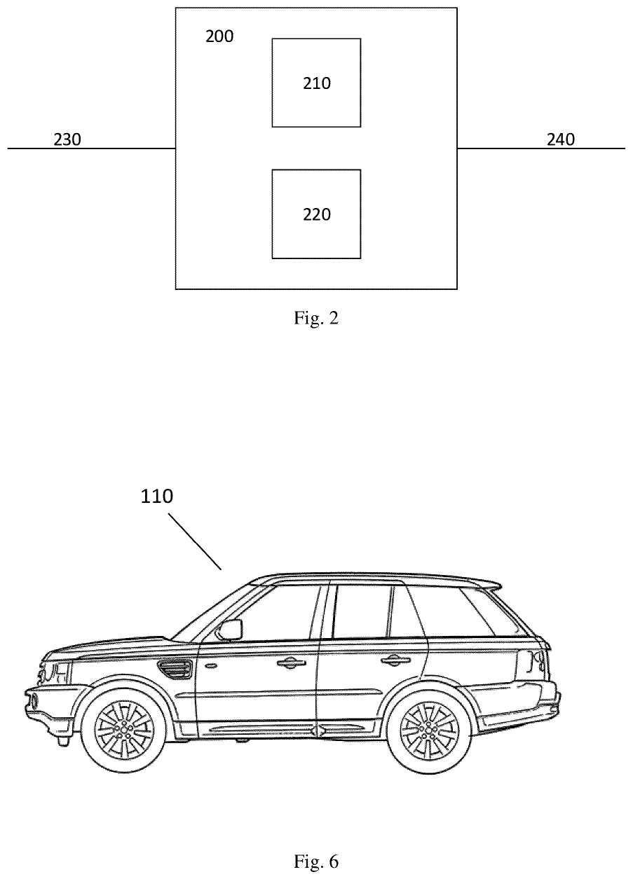

FIG. 2 illustrates a controller 200 or control unit 200 according to an embodiment of the invention, such as comprised in the vehicle 110 of FIGS. 1(a) and 1(b).

The controller 200 comprises a control means 210, input means 230 and output means 240. In some embodiments, the controller comprises a memory means 220 such as one or more memory devices 220 for storing data therein. The output means 240 may comprise an electrical output for outputting a manoeuvre signal. The manoeuvre signal represents an instruction for the vehicle 110 to move. The instruction provided by the manoeuvre signal is provided to cause the vehicle 110 to perform the defined manoeuvre. Here, the input means 230 is for receiving an environment signal indicative of the features 125, 140, 150 in the vicinity of the vehicle 110. The control means 210 is arranged to control the output means 240 to cause the vehicle 110 to perform at least a portion of the defined manoeuvre in dependence on the environment signal. Here, the controller 200 comprises a second output in the form of a notification output means for outputting a notification signal for notifying the user of a possibility of performance of a defined manoeuvre.

The control means 210 may be formed by one or more electronic processing devices such as an electronic processor. The processor may operably execute computer readable instructions stored in the one or more memory devices 220. The control means 210 is arranged to control the output means 240 to output the manoeuvre signal in dependence on the environment signal, as will be explained. In some embodiments, the input means 230 and output means 240 may be combined such as by being formed by an I/O unit or interface unit. For example, the control means 200 may comprise an interface to a network forming a communication bus of a vehicle. The interface bus may be an Internet Protocol (IP) based communication bus such as Ethernet, although embodiments of the invention are not limited in this respect.

The input means 230 may comprise an electrical input for receiving an environment signal. The input means 230 may comprise an electrical input for receiving a request signal. Here, the request signal is indicative of a wirelessly received signal representing a user request for movement of the vehicle 110.

As shown here, the memory means 220 can be used to store data from the input means 230. For example, the memory means can store data about the features 125, 140, 150, or the vacancy 172 for future use. For example, where an occupant or user of the vehicle 110 has actively selected (e.g. by inputting one or more parameter inputs) or implicitly shown (e.g. through a repeated behavioural or use pattern) a preference for a performance of a defined manoeuvre for one or more scenarios, the memory means can store data corresponding to the preference to provide a default and/or automatic parameter of the defined manoeuvre in dependence on the input (e.g. environment signal and/or location signal, etc) being indicative of a such or similar scenario for the preference or preferences. For example, where a user in a particular scenario repeatedly performs a user-initiated manoeuvre to a user-initiated manoeuvre end position prior to performance of a defined manoeuvre from the user-initiated manoeuvre end position, then the control means may be arranged to notify the user of the possibility of the performance of the defined manoeuvre in advance and/or during and/or upon completion of the user-initiated manoeuvre. Alternatively, the control means may be arranged to suppress notification of the possible defined manoeuvre-for example, where a user may appear to prefer only initiating the defined manoeuvre from the user-initiated manoeuvre end position and not a position prior thereto, then the notification of the possibility of the defined manoeuvre may be supressed, such as until the vehicle is at or near the user-initiated manoeuvre end position.

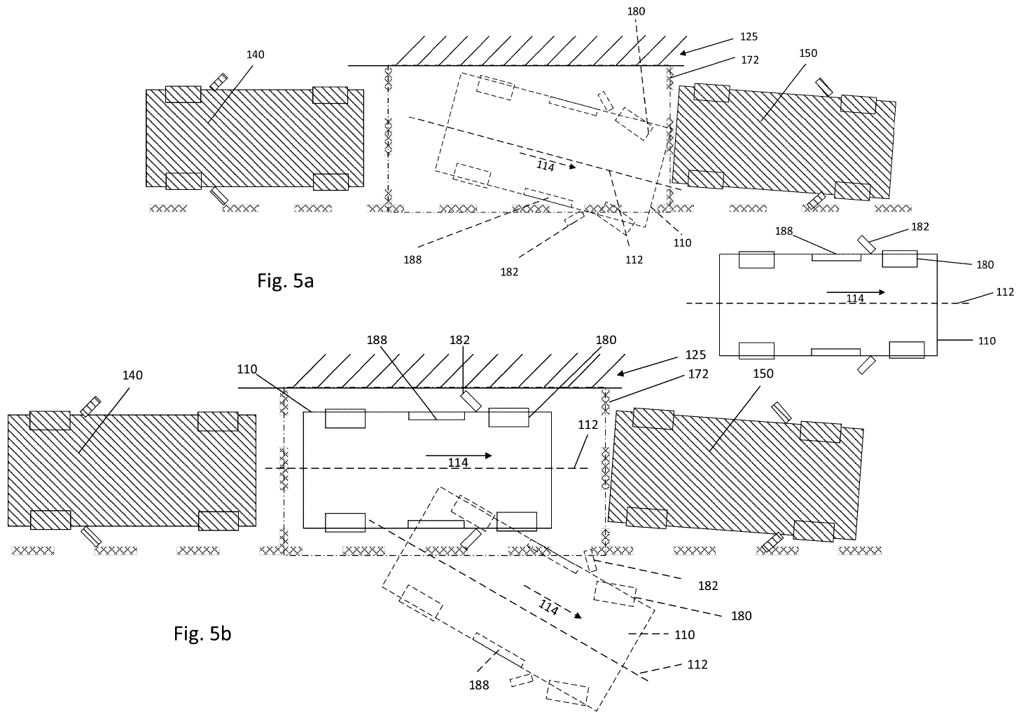

The data may be stored prior to and during performance of the defined manoeuvre, for use during the performance of the defined manoeuvre. In addition, or alternatively, the data may be stored for use during a subsequent defined manoeuvre. For example, where the data is stored prior to or during the performance of the user-initiated manoeuvre to arrive at the user-initiated manoeuvre end position of FIG. 1a or 1b, or the defined manoeuvre completed position of either of FIG. 5a or 5b, then the stored data may be used for or during a subsequent defined manoeuvre, such as an unparking manoeuvre from the defined manoeuvre completed position of FIG. 5b. Where stored data, such as of the features 125, 140, 150 is used for the performance of at least a portion of the defined manoeuvre, the controller 200 may perform a check, such as to the validity or continued validity of the data. For example, the controller 200 may corroborate the data with another input, such as with a later input from the environment sensing means, or input from another portion of the environment sensing means (e.g. another sensor or camera located at another portion of the vehicle 110, the another sensor or camera able to confirm the continued presence and/or position of the one or more features 125, 140).

In at least some examples, the control means 200 may comprise a second input means for receiving a request signal indicative of a received signal indicative of a user request, such as a wirelessly received signal. The user request may be for the performance of the defined manoeuvre to a target defined manoeuvre completed position.

It will be appreciated that the controller 200 may be arranged to perform a portion of the defined manoeuvre in a particular mode. For example, the user may initiate the manoeuvre with control in a first mode to perform a first portion of the manoeuvre, with control thereafter being in a different mode with the mode of performance being variable during the performance of the portion of the defined manoeuvre (e.g. between an occupant-in-vehicle mode and an occupant-out-of-vehicle mode).

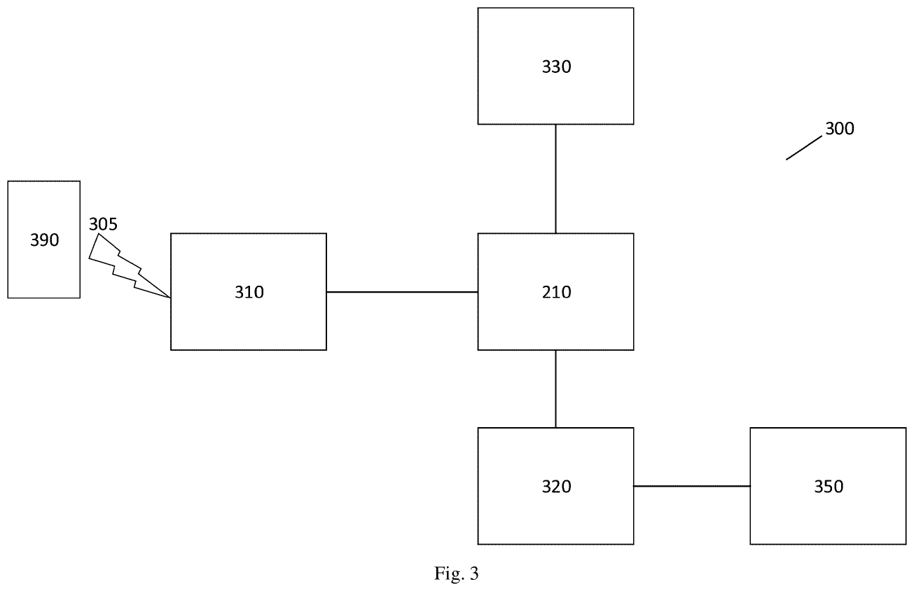

FIG. 3 illustrates a system 300 according to an embodiment of the invention. The system 300 comprises the control means 200 described above and shown in FIG. 2.

The system 300 comprises environment sensing means 330 for determining information about an environment of the vehicle 110. In particular, the environment sensing means 330 is provided for determining a location of one or more features in a vicinity of the vehicle 110. In at least some examples, a portion of the environment sensing means is associated with the one or more moveable projections 182, such as one or more sensors or cameras mounted in or on a vehicle wing mirror. The environment sensing means 330 is arranged to output an environment signal indicative of the determined features. The environment signal may be environment data which may be stored in the memory. The environment sensing means may comprise one or more sensing devices such as imaging devices, such as cameras, or other sensing devices such as LIDAR, radar, ultrasonic devices, sonar devices etc. Signals output by each of the sensing devices may be used to form a representation of the environment of the vehicle 110 which is stored in the memory for use by other systems of the vehicle 110.

Here, the environment sensing means 330 is arranged to determine a location of features such as surface markings, which may be painted lines denoting a perimeter of a parking bay, for example, or objects such as walls, posts or other vehicles in relation to which the vehicle is required to manoeuvre. The control means is arranged to determine an absence of features, such as a separation between obstructive features, such as the adjacent features 140, 150 shown here, in dependence on the environment signal. Accordingly, the control means is arranged to determine a vacancy 172 where no features, such as no obstructive features, are located. Where the vacancy 172 is sufficiently great, the control means is arranged to determine a vehicle envelope suitable for receiving the vehicle 110 in the defined manoeuvre completed position. The vehicle envelope comprises a target position suitable for receiving the vehicle 110 in the defined manoeuvre completed position. As such, the vehicle envelope here comprises a target defined manoeuvre completed position. In at least this example, the vehicle envelope is determined in dependence on a one-dimensional property and/or measurement and/or estimation. In particular, here, the vehicle envelope is determined in dependence on the environment signal being indicative of a length, such as an unobstructed length between features 140, 150. The unobstructed length is sufficiently long for receiving the vehicle 110 in the defined manoeuvre completed position, the length here being a separation between features 140, 150 that is greater than the vehicle length in the defined manoeuvre completed position. The manoeuvre may comprise, for example, parking to a parked position.

The control means 200 of the system 300 here comprises defined manoeuvre means. The control means is arranged to control the vehicle 110 to perform at least one defined manoeuvre. The control means 200 may comprise a defined manoeuvre controller for controlling one or more systems of the vehicle 110 to perform one or more defined manoeuvres. The defined manoeuvre means may be associated with one or more actuators 350 of the vehicle 110. The one or more actuators 350 are provided for effecting movement of the vehicle 110. The actuators may comprise one or more of a power steering mechanism arranged to provide steering of wheels of the vehicle 110 in dependence on signals received from the control means 200. A second actuator may comprise a powered braking mechanism of the vehicle 110 which is arranged to actuate brakes of the vehicle in dependence on signals received from the control means 200. A third actuator comprises the powertrain of the vehicle. The control means 200 is arranged to control the steering of the vehicle wheel 180 relative to the feature 125. A fourth actuator 350 comprises one or more mechanisms for altering the position of the one or more moveable projections 182.

The system 300 shown here comprises a motive control means 320. The motive control means 320 may be a motive control unit. The motive control means 320 is arranged to receive the manoeuvre signal output by the control means 200. The motive control means 320 is associated with one or more motive units of the vehicle 110 which may form part of a powertrain (not shown) of the vehicle 110. The motive units may comprise one or more of an internal combustion engine and one or more electric machines of the vehicle 110. The powertrain is arranged to provide power, or torque, to cause movement in the longitudinal axis of the vehicle 110 i.e. forward or backward movement of the vehicle 100 in dependence on the manoeuvre signal received from the control means 200. The motive control means 320 is arranged to control the application of torque to one or more wheels of the vehicle 110 to move the vehicle 110 in the longitudinal axis of the vehicle i.e. to move the vehicle generally forwards or backwards. The torque may comprise driving torque i.e. applied in a direction of desired movement, such as forwards. The torque may also comprise braking torque i.e. applied to resist the driving torque. In at least some embodiments both driving torque and braking torque may be applied simultaneously in order to provide low-speed movement of the vehicle 110. The braking torque may also be applied at least partly after the driving torque in order to effect accurate movement of the vehicle 110. To achieve control of the steering, the control means 200 may communicate with the motive control means 320. Thus, the one or more actuators 350 can control a direction and movement of the vehicle to perform the defined manoeuvre. The defined manoeuvre is performed in dependence on the environment signal provided by the environment sensing means 330.

The one or more defined manoeuvres which may be performed by the vehicle 110 under control of the control means 200 may comprise a parking manoeuvre, such as shown in FIG. 5b wherein the vehicle 110 is controlled to arrive at a parked position.

As shown here, the system 300 comprises a receiver means 310 for receiving a signal 305. The signal 305 may be wirelessly received from a mobile device 390 associated with a person responsible for the vehicle 110. The signal 305 is indicative of a user request for vehicle movement of the vehicle 110, as noted above. The receiver means 310 is arranged to output the request signal to the input means 230 of the control means 200 as described above. The request signal may be output by the receiver means 310 onto a communication bus of the vehicle 110 which may communicably couple the components of the system 300.

The receiver means 310 may be in the form of a radio unit 310. The radio unit 310 may comprise a receiver for receiving radio signals 305 from the mobile device 390. In some embodiments, the radio unit 310 may also comprise a transmitter, or may be a transceiver 310 configured to receive radio signals 305 transmitted from the mobile device 390 and transmit signals to the mobile device 390. The radio unit 103 and the mobile device 390 may be arranged to provide a wireless local area network, via which two-way communication may take place between the radio unit 103 and the mobile device 390. For example, the radio unit 103 may be arranged to communicate by WiFi® with the mobile device 390. In alternative embodiments, other radio communication standards may be used for the communication. In one example, communication between the radio unit 103 and the mobile device 390 is provided via Bluetooth®), although other protocols or standards may be envisaged.

The mobile device 390 may be an electronic key fob associated with the vehicle 110, such as may be used to gain entry and to activate or power up the vehicle 110. The mobile device 390 may, in other embodiments, be an electronic device associated with the person responsible for the vehicle 100 such as a mobile telephone, tablet, watch, wearable electronic device or other computing device associated with the person. The mobile device 390 is capable of receiving a user input indicating the person's desire to move the vehicle 110. The user input may be provided in the form of a button or key press, activation of a graphically displayed icon, a gesture or voice command. Other forms of user input may also be envisaged.

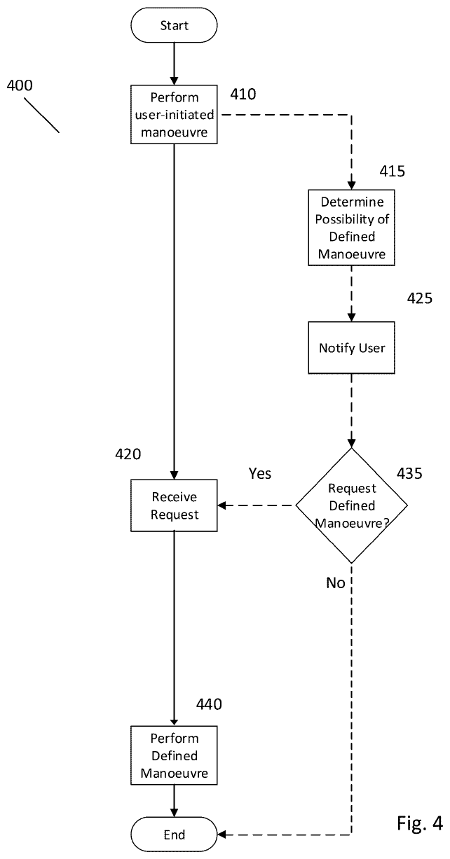

FIG. 4 illustrates a method 400 according to an embodiment of the invention. The method 400 is a method of controlling movement of the vehicle 110. The method 400 may be formed by the control means 200 and system 300 described above with reference to FIGS. 2 and 3. The method 400 will be described with reference to FIGS. 5a and 5b as examples which correspond to the scenarios shown in FIGS. 1a and 1b respectively.

The method 400 broadly comprises steps of performing 405 a user-initiated manoeuvre, receiving 410 the environment signal from the environment sensing means 330 which is indicative of a feature 125, 140, 150 in a vicinity of the vehicle 110 and, in dependence thereon, determining 415 a possibility of performing a defined manoeuvre. Thereafter, the user has the option to request the performance of the defined manoeuvre. Upon receipt 420 of the user request, the control means 220 controls the manoeuvre output means 240 to move the vehicle 110 to the completed position of the defined manoeuvre. In the example shown in FIG. 5a, following completion of the defined manoeuvre 440, normal driving can be performed. For example, the user can perform manually-controlled driving to drive the vehicle 110 away from the scenario of FIG. 5a entirely.

Referring to FIG. 4, the illustrated embodiment of the method 400 comprises a step of receiving 410 the environment signal from the environment sensing means 330. The control means 200 determines 415 whether the environment signal is indicative of one or more features 125, 140, 150 in the vicinity of the vehicle 110 corresponding to whether the vehicle 110 can perform the defined manoeuvre. In at least some examples, the possibility of performance of the defined manoeuvre is notified 425 to the user, explicitly alerting the user to the availability of control transfer. Here, the control means 210 is arranged to control the notification output means to output the notification signal independently of a user request for the manoeuvre output means 240 to be controlled by the control means 210. In at least some examples, the controller 200 is configured to automatically output the notification signal without requiring an activation of the control means 210 by the vehicle user. In at least some scenarios, the user may otherwise be unaware of the possibility of the performance of a defined manoeuvre, such that allowing the notification signal to be output independently of the user request may allow the user to be offered the possibility of more or more useful defined manoeuvres (e.g. compared to only those expressly sought by the user in advance).

In FIG. 5a the vehicle 110 is shown at the defined manoeuvre completed position outside the vacancy 172, where the defined manoeuvre has been performed with the vehicle performing an unparking defined manoeuvre to exit the vacancy 172 with multiple trajectory portions to perform the defined manoeuvre. The vehicle 110 is shown in relation to the feature 125 in a vicinity of the vehicle 110. The feature 125 is, in this example, an object which is a wall that is parallel to the longitudinal axis 112 of the vacancy 172. The object is not limited to being a wall 125 and may be, for example, a bollard, fence, barrier, or other object at or adjacent the vacancy 172, such as to form a boundary thereof. As shown in FIGS. 1a and 5a, another feature 140, in the form of a stationary vehicle is located at an end of the vacancy 172, to the rear of the vehicle 110 as shown in FIG. 1a. As shown in FIGS. 1a and 5a, another stationary vehicle 150 is located at an opposite end of the vacancy, in front of the vehicle 110 in the position as shown in FIG. 1a.

FIG. 5a shows the vehicle 110 following an unparking defined manoeuvre from the position of FIG. 1a, the position of FIG. 1a shown in FIG. 5a in broken lines. The vehicle 110 is shown as having moved in a rearwards direction, opposite to the forward longitudinal direction 114, and also in the forward direction 114, with controlled operation of steerable wheels 180 to angle the vehicle 110 to perform sequential trajectory parts of the unparking defined manoeuvre from the position of FIG. 1a to the defined manoeuvre completed position of FIG. 5a. Accordingly, the vehicle 110 can be moved out of the vacancy 172 of FIGS. 1a and 5a.

It will be appreciated that in at least some such scenarios, multiple trajectory parts may be required to iteratively transition the vehicle 110 out of the vacancy 172. It will be appreciated that although shown here in plan view, the scenarios depicted are three dimensional.

As can be seen in FIG. 5a, the vehicle 110 in the defined manoeuvre completed position (on the right, outside the vacancy 172 as shown in FIG. 5a) is positioned adjacent foremost stationary vehicle 150, with a clearance therebetween. From the defined manoeuvre completed position of FIG. 5a, the vehicle 110 may be driven normally, such as manually. It will be appreciated that the particular scenario of FIG. 5a may correspond to a scenario whereby the vehicle 110 in the defined manoeuvre completed position is correctly positioned for driving off normally, such as with a direction or a flow of traffic. For example, the vehicle 110 may be positioned on a road where vehicles drive on the left-hand side of the road (e.g. in the UK), such that the vehicle 110 is not pointed into oncoming traffic in the particular scenario shown in FIG. 5a. From the defined manoeuvre completed position, a user may have or take control of the vehicle 110, following completion of the defined manoeuvre.

FIG. 5b shows the vehicle 110 following the parking defined manoeuvre from the position of FIG. 1b, the position of FIG. 1b shown in FIG. 5b in broken lines. In FIG. 5b the vehicle 110 is shown at the defined manoeuvre completed position inside the vacancy 172, where the defined manoeuvre would be performed with the vehicle performing a parking-in defined manoeuvre to enter the vacancy 172. The vehicle 110 is shown in relation to the feature 125 in the vicinity of the vehicle 110. It will be appreciated that in at least some such scenarios, multiple trajectory parts may be required to iteratively transition the vehicle 110 to the defined manoeuvre completed position in the vacancy 172. It will also be appreciated, that the defined manoeuvre performed may involve correcting or reversing at least some of the user-initiated manoeuvre. For example, performing the defined manoeuvre from the position of FIG. 1b to the position of FIG. 5b may include entirely removing the vehicle 110 from the vacancy 172 (e.g. to a defined manoeuvre intermediate position similar to the defined manoeuvre completed position of FIG. 5a) during the parking defined manoeuvre shown in FIG. 5b. Although shown in FIG. 1b as only partially in the designated parking space and vacancy 172, it will also be appreciated that the vehicle 110 may be fully positioned, or at least more fully positioned, in the designated parking space and vacancy 172. For example, the user may position the vehicle 110 in the vacancy 172, with the defined manoeuvre effectively “tidying” the vehicle's 110 final parked position (e.g. to the solid line position of FIG. 5b). In at least some examples, such tidying may be performed with the user out of the vehicle 110, such as retrospectively. Accordingly, the user may position the vehicle 110 loosely or roughly in, partially in or near, the vacancy 172-with the controller 200 effectively finishing-off the parking manoeuvre as a defined manoeuvre, with the output means 230 controlled by the control means 210.

Accordingly, the user-initiated manoeuvres to the end positions of FIGS. 1a and 1b have been continued as defined manoeuvres to the defined manoeuvre completed positions of FIGS. 5a and 5b respectively.

In at least some examples, the user can request the defined manoeuvre performance by an explicit selection or by performing one or more predetermined actions, such as selected from one or more of: touching or putting a hand on a steering wheel; activating an accelerator control (e.g. pressing a pedal);

The controller 200 may be arranged to notify and/or define a trajectory for the performance of the defined manoeuvre in dependence on the environment signal, such as the properties of the vacancy 172 and/or the features 125, 140, 150. For example, the controller 200 may be arranged to notify and/or define the trajectory in dependence on the size of the vacancy 172, the alignment or proximity of the adjacent objects 140, 150, or other parameters associated with the vacancy 172. Additionally, or alternatively, the controller 200 may be arranged to notify and/or define the trajectory in dependence on other parameters, such as one or more of: an ambient environmental condition (e.g. rain, temperature, lightness, darkness, time of day, day of week, etc); a terrain condition (e.g. road surface condition, off-road surface condition, gradient, etc); a location or locations of multiple vehicle occupants, such as the location of each vehicle occupant.

The control means 200 may be arranged to allow for user adaptation. For example, the user may be able to at least partially override, program or adjust the control means 200 for one or more of the following: a parameter of the defined manoeuvre; a scenario whereby the defined manoeuvre or at least notification thereof is suppressed; the available mode or modes; the one or more inputs for determination of the available modes; a selection means for selecting the mode. The control means 200 may be arranged to be manually overridden, programmed or adjusted, such as to adjust the output of the manoeuvre and/or notification signal. Additionally, or alternatively, the control means 200 may be arranged to automatically, or semi-automatically, override, program or adjust the output of the manoeuvre and/or notification signal, such as by learning from a user behaviour, such as a repeated user behaviour, associated with one or more of: an input pattern; a geographic location; a user identity (e.g. where the vehicle 110 is used non-contemporaneously by multiple users). For example, the control means 200 may be arranged to automatically select a default mode or parameter when the occupant 195 is located at a particular location (e.g. relative to the vehicle 110); or when the vehicle 110 is positioned at a particular location, such as a home or garage where the user has previously performed a defined manoeuvre out of a known vacancy.

It will be appreciated that other defined manoeuvres than illustrated may be performed. For example, the defined manoeuvre may comprise an unparking manoeuvre from a perpendicular parking lot space (in contrast to the illustrated parallel, on-street unparking manoeuvre). It will be appreciated that the controller 200 may be arranged to allow occupant movement between in and out of vehicle locations during the performance of the defined manoeuvre. For example, the controller 200 may be arranged to allow interruption or pausing of the defined manoeuvre, such as to allow the occupant 195 to move into or out of the vehicle 110 whilst the vehicle 110 is stationary. In at least some examples, the vehicle 110 may have steerable rear wheels; or the vacancy may comprise a fishbone (diagonal) vacancy 172 or a perpendicular vacancy (e.g. with the vehicle 110 parked end on).

As a result of the method 400 the vehicle may be more advantageously positioned or configured following performance of a defined manoeuvre. It will also be appreciated that embodiments of the present invention are not limited to being useful in association with a defined manoeuvre. It may be useful to notify the user of the possibility of the defined manoeuvre, even where the user may not request or wish performance of the defined manoeuvre. For example, notifying the user of such a possibility may alert the user to a possibility of performing a user-initiated manoeuvre along a trajectory similar to the indicated possible defined manoeuvre.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine-readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A controller comprising:
input means for receiving an input signal;
manoeuvre output means for outputting a manoeuvre signal to cause a vehicle to perform a defined manoeuvre;
control means arranged to control the manoeuvre output means;
notification output means for outputting a notification signal for notifying a user; and
request input means for receiving a request signal indicative of a user request for a transfer of control from the user to the control means for a continuance of a user-initiated manoeuvre as a defined manoeuvre; the control means being arranged to control the manoeuvre output means to perform the defined manoeuvre from a user-initiated manoeuvre end position in dependence on the request signal.

2. The controller of claim 1, wherein the control means is arranged to detect performance of the user-initiated manoeuvre, in dependence on the input signal; and the control means is arranged to control the notification output means to notify the user of the detection by the control means of the user-initiated manoeuvre.

3. The controller of claim 2, wherein the control means is arranged to control the notification output means to automatically output the notification signal on detection by the control means of the user-initiated manoeuvre and to offer the user continuance as a defined manoeuvre.

4. The controller of claim 2, wherein the control means is arranged to control the notification output means to output the notification signal independently of a user request for the manoeuvre output means to be controlled by the control means.

5. The controller of claim 1, wherein the control means is arranged to control the notification output means in dependence on the input signal received prior to the user-initiated manoeuvre to the user-initiated manoeuvre end position, and/or optionally, wherein the control means is configurable to suppress the notification output means from notifying the vehicle user of the detection by the control means of the user-initiated manoeuvre.

6. The controller of claim 1, wherein the control means is arranged to control the manoeuvre output means to cause the vehicle to follow a planned trajectory from the user-initiated manoeuvre end position to a defined manoeuvre completed position and optionally, wherein the planned trajectory comprises at least a partial correction of the user-initiated manoeuvre performed prior to the user request.

7. The controller of claim 1, comprising memory means for storing data therein, the memory means being arranged to store data received via the input means, and optionally:
wherein the stored data is indicative of a previously performed defined manoeuvre; and the control means is arranged to control the manoeuvre output means to cause the vehicle to selectively perform a repetition of at least a portion of the previously performed defined manoeuvre, and/or,
wherein the stored data is indicative of a previously performed defined manoeuvre; and the control means is arranged to control the manoeuvre output means to cause the vehicle to perform a reversal of at least a portion of the previously performed defined manoeuvre, and/or,
wherein the stored data is indicative of a previously performed user-initiated manoeuvre; and the control means is arranged to control the notification output means to notify the user in dependence on the previously-performed user-initiated manoeuvre having been followed by a defined manoeuvre.

8. The controller of claim 1, wherein the input means is arranged to receive a plurality of input signals from a plurality of input sources, the plurality of input signals being selected from at least:
an environment signal indicative of a feature in a vicinity of the vehicle;
a motion signal indicative of a motion of the vehicle;
a steering signal indicative of a user steering;
an event signal indicative of a vehicle event; and
a location signal indicative of a geographical location.

9. A method of controlling movement of a vehicle to perform a defined manoeuvre, the method comprising:
performing a user-initiated manoeuvre to a user-initiated manoeuvre end position;
receiving a request signal indicative of a user request to transfer control from a user to a control means for a continuance of the user-initiated manoeuvre as a defined manoeuvre;
controlling with the control means a manoeuvre output means to output a manoeuvre signal to cause the vehicle to perform the defined manoeuvre from the user-initiated manoeuvre end position.

10. The method of claim 9 comprising receiving an input signal; and outputting a notification signal for notifying a user.

11. The method of claim 10, comprising, in dependence on the input signal, detecting with the control means the user-initiated manoeuvre, notifying the user of the detection by the control means of the user-initiated manoeuvre, and offering transfer of control to the control means for the continuance of the user-initiated manoeuvre as the defined manoeuvre.

12. The method of claim 9, comprising allowing the vehicle to revert to user control prior to completion of the defined manoeuvre to a defined manoeuvre completed position.

13. The method of claim 9, comprising determining a location of one or more features in a vicinity of the vehicle with an environment sensing means, and/or comprising receiving a signal from a mobile device indicative of a user request to perform the defined manoeuvre.

14. A vehicle comprising the controller according to claim 1.

15. A non-transitory, computer-readable medium having stored thereon computer software that, when executed by a processing means, is arranged to perform the method according to claim 9.
